(19) United States
(12) Patent Application Publication
(10) Pub. No.: US 2025/0007433 A1
(43) Pub. Date: Jan. 2, 2025

(54) METHOD AND DRIVER CIRCUIT FOR SENSORLESS STEPPER MOTOR BACK ELECTROMOTIVE FORCE DETECTION

(71) Applicant: Chengdu Monolithic Power Systems Co., Ltd., Chengdu (CN)

(72) Inventors: Jian Zhao, Hangzhou (CN); Yunping Lang, Hangzhou (CN)

(21) Appl. No.: 18/757,140

(22) Filed: Jun. 27, 2024

(30) Foreign Application Priority Data
Jun. 28, 2023 (CN) 202310779937.2

(51) Int. Cl. H02P 8/34

(52) U.S. Cl. CPC H02P 8/34

(57) ABSTRACT

A method of detecting a back electromotive force in a stepper motor having two full bridge circuits is provided. The method includes stepping the stepper motor into a zero-current step interval having a sequential first-time interval and a second time interval, determining a zero-crossing direction of the current flowing through a first winding in which the current drops to zero in the first time interval. In the second time interval, a specific low side switch is controlled to keep in a conduction state in response to the zero-crossing direction, the specific low side switch is coupled to a first terminal of the first winding. A voltage at a second terminal of the first winding is sampled for providing the back electromotive force.

### CROSS-REFERENCE TO RELATED APPLICATIONS

This application claims the benefit of CN application No. 202310779937.2, filed on Jun. 28, 2023, and incorporated herein by reference.

### TECHNICAL FIELD OF THE INVENTION

The present invention generally relates to electronic circuits, and more particularly but not exclusively, to a sensorless stepper motor and associated driver circuits and methods for back electromotive force detection.

### BACKGROUND OF THE INVENTION

Stepper motors can divide one complete rotation into multiple equal steps and have excellent performance in precise control, thus are good choices for motion control systems. In most applications, it is required to detect the status of the stepper motor, for example, to detect whether the motor is stuck. If there is no stall detection, when a stall occurs, the problems such as mechanical failures and audible noise will occur once the motor continues to be driven through an obstacle. Position sensors or hall sensors are traditionally used in the stall detection, which leads to high complexity and high price.

### SUMMARY OF THE INVENTION

An embodiment of the present invention discloses a method of detecting a back electromotive force in a stepper motor. The stepper motor has two full bridge circuits and two windings respectively driven by the two full bridge circuits. The method comprises the following steps. The stepper motor is stepped into a zero-current step interval having a sequential first time interval and a second time interval. A current flowing through a first winding drops to zero in the first time interval. A zero-crossing direction of the current flowing through the first winding is determined. In the second time interval, a specific low side switch is controlled to keep in a conduction state in response to the zero-crossing direction of the current. The specific low side switch is coupled to a first terminal of the first winding. A voltage at a second terminal of the first winding is sampled. The back electromotive force is provided based on the sampled voltage.

Another embodiment of the present invention discloses a stepper motor. The stepper motor comprises two windings, a rotor and a driver circuit. The driver circuit comprises two full bridge circuits configured to respectively drive the two windings. The driver circuit is configured to determine a zero-crossing direction of a current flowing through a first winding in which the current drops to zero in a zero-current step interval. The zero-current step interval has a sequential first time interval and a second time interval. In the first time interval, the current flowing through the first winding drops to zero. In the second time interval, the driver circuit is configured to control a specific low side switch coupled to a first terminal of the first winding to keep in a conduction state in response to the zero-crossing direction of the current. The driver circuit is further configured to provide a back electromotive force induced by the first winding by sampling a voltage at a second terminal of the first winding.

Yet another embodiment of the present invention discloses a driver circuit for a stepper motor. The driver circuit comprises an input terminal, a direction terminal, a first pair of output terminals, a second pair of output terminals, and two full bridge circuits. The input terminal is connected to receive a step signal. The direction terminal is connected to receive a direction signal. The first pair of output terminals are respectively coupled to a first terminal and a second terminal of a first winding. The second pair of output terminals are respectively coupled to a first terminal and a second terminal of a second winding. The two full bridge circuits are configured to respectively drive the first winding and the second winding. The driver circuit is configured to determine a zero-crossing direction of a current flowing through the first winding in which the current drops to zero in a zero-current step interval. During the zero-current step interval, in a time interval following the zero-crossing of the current, in response to the zero-crossing direction, the driver circuit is configured to control a specific low side switch coupled to the first terminal of the first winding to keep in a conduction state and to provide a back electromotive force by sampling a voltage at the second terminal of the first winding.

### BRIEF DESCRIPTION OF DRAWINGS

The present invention can be further understood with reference to the following detailed description and the appended drawings, wherein like elements are provided with like reference numerals.

FIG. 1 shows a block circuit diagram of a two-phase stepper motor 100 in accordance with an embodiment of the present invention.

FIG. 2 shows working waveforms of driving currents in a two-phase bipolar stepper motor in accordance with an embodiment of the present invention.

FIG. 3 shows a schematic diagram of a two-phase stepper motor 100A in accordance with an embodiment of the present invention.

FIG. 4 shows a flow diagram of a method for detecting a back electromotive force in a stepper motor in accordance with an embodiment of the present invention.

FIG. 5 shows a flow diagram of a method for detecting a back electromotive force in a stepper motor in accordance with another embodiment of the present invention.

FIG. 6 shows working waveforms of a back electromotive force detection in a stepper motor in accordance with another embodiment of the present invention.

FIG. 7 shows working waveforms of a stepper motor when stall occurs or no stall in accordance with an embodiment of the present invention.

FIG. 8 shows a circuit diagram of a back electromotive force detection circuit in accordance with an embodiment of the present invention.

FIG. 9 shows working waveforms of a back electromotive force detection in a stepper motor in accordance with yet another embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to “one embodiment”, “an embodiment”, “an example” or “examples” means: certain features, structures, or characteristics are contained in at least one embodiment of the present invention. These “one embodiment”, “an embodiment”, “an example” and “examples” are not necessarily directed to the same embodiment or example. Furthermore, the features, structures, or characteristics may be combined in one or more embodiments or examples. In addition, it should be noted that the drawings are provided for illustration, and are not necessarily to scale. And when an element is described as “connected” or “coupled” to another element, it can be directly connected or coupled to the other element, or there could exist one or more intermediate elements. In contrast, when an element is referred to as “directly connected” or “directly coupled” to another element, there is no intermediate element.

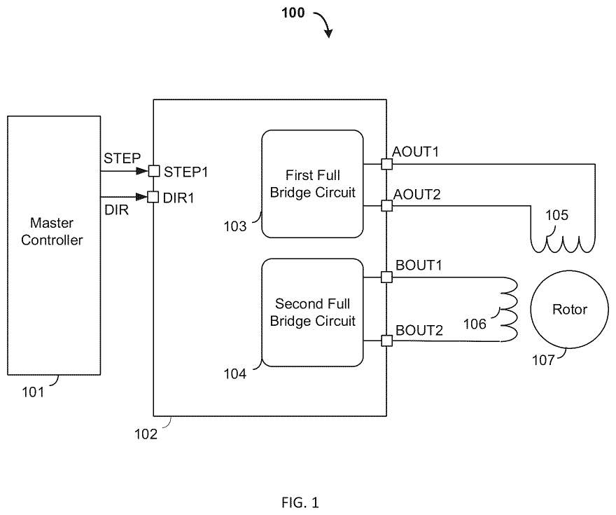

FIG. 1 shows a block circuit diagram of a two-phase stepper motor 100 in accordance with an embodiment of the present invention. As shown in FIG. 1, the stepper motor 100 comprises a master controller 101, a driver circuit 102, two stator windings 105 and 106, and a rotor 107.

The master controller 101 has at least two outputs coupled to the driver circuit 102. The two outputs of the master controller 101 comprises a step signal STEP and a direction signal DIR. The step signal STEP is coupled to an input pin STEP1 of the driver circuit 102. The direction signal DIR is coupled to a direction pin DIR1 of the driver circuit 102.

The step signal STEP indicates a step distance that the stepper motor 100 needs to move. The direction signal DIR indicates a rotation direction of the stepper motor 100, such as clockwise or counterclockwise rotation. The master controller 101 may include a microprocessor, a microcontroller unit, or other logic device. The master controller 101 provides the step signal STEP and the direction signal DIR to the driver circuit 102. In response to the step signal STEP and the direction signal DIR, the driver circuit 102 provides respectively a first drive control signal and a second drive control signal to the two full bridge circuits 103 and 104.

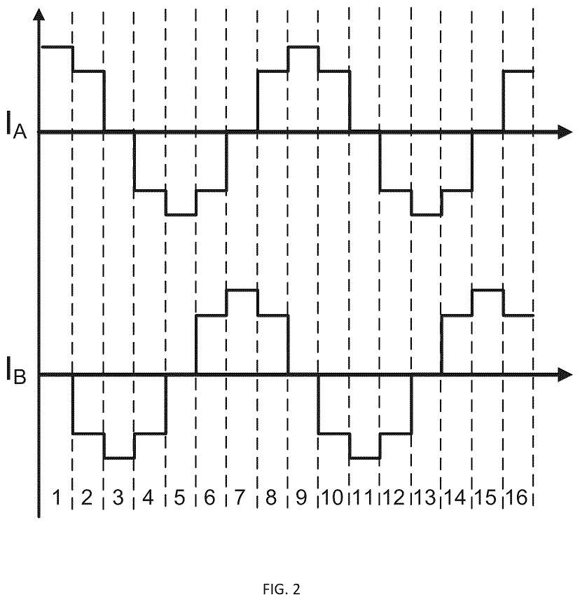

The two full bridge circuits 103 and 104 are both H-bridge circuits each having four switches, which are coupled to a first stator winding 105 and a second stator winding 106, respectively. The two full bridge circuits 103 and 104 provide different driving current combinations for the two windings 105 and 106. In detail, in response to the step signal STEP, a position of the rotor 107 is determined according to the combination of the currents IA and IB flowing through the windings 105 and 106, so that the rotor 107 moves in a step rotation, as shown in FIG. 2. Under the periodic control of the first and second drive control signals, by controlling the on and off of the eight switches in the two full-bridge circuits 103 and 104, the current IA and IB flowing through the first winding 105 and the second winding 106 are controlled to be close to current setting values.

Since the stepper motor 100 uses a permanent magnet as the rotor 107, whenever the rotor 107 rotates, a back electromotive force is induced in the stator windings 105 and 106.

A method for detecting the back-electromotive force induced by a moving rotor in stator windings where these voltages can be measured only in the time intervals when there is no current through the stator windings. However, since detecting a difference between two voltages at the two terminals of the stator winding requires at least two operational amplifiers, and it needs to perform a subtraction operation to the two detected terminal voltages, and thus the detection speed is slow and the detection has a large delay.

In the embodiment shown in FIG. 1, in a zero-current step interval, a current flowing through one winding drops to zero. The zero-current step interval is corresponding to a zero-current step signal ZCS decoded from the step signal STEP. The first and second drive control signals are configured to control a specific low side switch to keep in a conduction state in response to a zero-crossing direction of the current. In one embodiment, the zero-crossing direction of the current is from positive to zero. In another embodiment, the zero-crossing direction of the current is from negative to zero. In yet another embodiment, the zero-crossing direction of the current can be set to be from a first terminal to a second terminal of one winding, or from the second terminal to the first terminal of the winding in which the current drops to zero in the zero-current step interval. The specific low side switch coupled to one terminal of the winding is controlled to be in conduction state, and a voltage at the other terminal of the winding is sampled and used as the back electromotive force.

FIG. 2 shows working waveforms of driving currents in a two-phase bipolar stepper motor in accordance with an embodiment of the present invention. In the embodiment shown in FIG. 2, the stepper motor adopts half-step drive mode, and each working cycle has eight step intervals. In other embodiments, for example, when using driving modes such as ¼ step, ⅛ step, 1/32 step, etc., each working cycle will have more step intervals.

In one embodiment, the back electromotive force is allowed to be detected only within the zero-current step interval. There are four zero-current step intervals during one working cycle of the two-phase bipolar stepper motor. In each zero-current step interval, there is one winding in which no current flows, that is, the current drops to zero. In the zero-current step interval, a specific low side switch is controlled to keep in a conduction state in response to the zero-crossing direction of the current. The specific low side switch is coupled to the first terminal of the winding in which the current drops to zero. In this way, the back electromotive force can be obtained by simply measuring a voltage at the second terminal of the winding in which the current drops to zero.

In the embodiment shown in FIG. 2, the current flowing through the winding 105 is IA. In the zero-current step intervals 3 and 7, the back electromotive force induced by the winding 105 can be provided. In detail, in the zero-current step interval 3, the zero-crossing direction of the current IA is from positive to zero. In the zero-current step interval 7, the zero-crossing direction of the current IA is from negative to zero.

Similarly, the current flowing through the winding 106 is IB. In the zero-current step intervals 1 and 5, the back electromotive force induced by the winding 106 can be detected and provided. In detail, in the zero-current step interval 1, the zero-crossing direction of the current IB is from positive to zero, and in the zero-current step interval 5, the zero-crossing direction of the current IB is from negative to zero.

In one embodiment, each zero-current step interval at least comprises a sequential first time interval and a second time interval. In the first time interval, the current gradually drops to zero, the detection of the back electromotive force is not allowed. The back electromotive force detection is only allowed in the second time interval after the first time interval. In detail, in the second time interval, in response to the zero-crossing direction of the current, the specific low side switch is controlled to be in conductive state. The specific low side switch is coupled to the first terminal of the winding in which the current drops to zero in the first time interval. A voltage at the second terminal of the winding in which the current drops to zero in the first time interval is sampled, to provide as the back electromotive force.

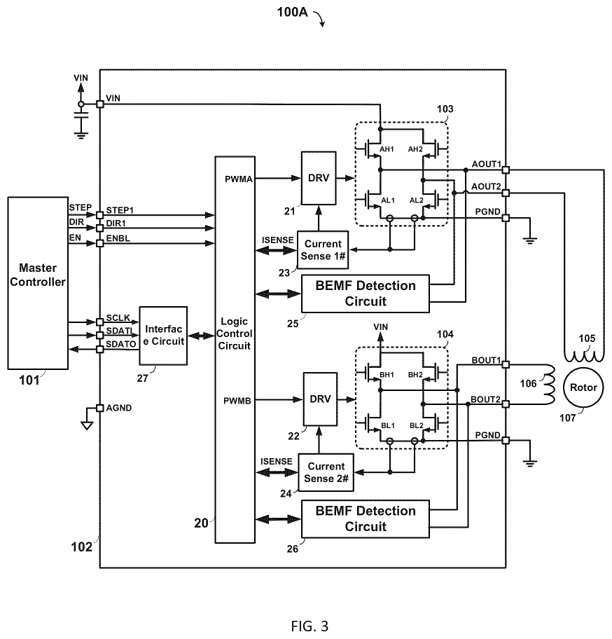

FIG. 3 shows a schematic diagram of a two-phase stepper motor 100A in accordance with an embodiment of the present invention. As shown in FIG. 3, the stepper motor 100A comprises a master controller 101, a driver circuit 102, two windings 105 and 106, and a rotor 107.

In the embodiment shown in FIG. 3, the driver circuit 102 is a monolithic integrated circuit. The driver circuit 102 comprises a first full bridge circuit 103 and a second full bridge circuit 104, a logic control circuit 20, a first gate driver 21 and a second gate driver 22, a first current sense circuit 23 and a second current sense circuit 24, a first back electromotive force (BEMF) detection circuit 25 and a second back electromotive force detection circuit 26, and an interface circuit 27.

It should be noted that the illustrated embodiments described herein are merely exemplary implementations, and not for the purpose of limiting the invention. In other embodiments, the first and second back electromotive force detection circuits 25 and 26 may be realized by a single detection circuit.

As shown in FIG. 3, the master controller 101 has three outputs all coupled to the driver circuit 102. The three outputs of the master controller 101 are configured to provide a step signal STEP, a direction signal DIR, and an enable signal EN, respectively, and are coupled to a step pin STEP1, a direction pin DIR1 and an enable pin ENBL, respectively. In response to the step signal STEP, the direction signal DIR and the enable signal EN, the logic control circuit 20 is activated and is configured to provide a first drive control signal PWMA and a second drive control signal PWMB to the gate drivers 21 and 22.

As shown in FIG. 3, the first full bridge circuit 103 comprises a H-bridge circuit having four switches AH1, AH2, AL1 and AL2. The four switches are consisted of two legs, each leg has a high side switch and a low side switch. The common nodes of the two legs are coupled to a first pair of output terminals AOUT1 and AOUT2. Similarly, the second full bridge circuit 104 comprises a H-bridge circuit having four switches BH1, BH2, BL1 and BL2. The four switches are consisted of two legs, each leg has a high side switch and a low side switch. The common nodes of the two legs are coupled to a second pair of output terminals BOUT1 and BOUT2.

Under periodic control of the first drive control signal PWMA and the second drive control signal PWMB, the gate drivers 21 and 22 control the current flowing through the first winding 105 and the second winding 106 by controlling the on and off of the eight switches in the full bridge circuits 103 and 104. In a further embodiment, the driver circuit 102 may work in a micro-stepping mode and is configured to have a programmable current configuration table to provide current setting values, which can flexibly adapt to the working conditions of the stepper motor 100A. The current sense circuits 23 and 24 are coupled to the full bridge circuits 103 and 104 respectively, and respectively provide current sense signals (ISENSE) indicative of the current flowing through a respective winding to the corresponding gate driver. Based on the current setting values in the programmable current configuration table and the current sense signals (ISENSE), the logic control circuit 20 provides the first drive control signal PWMA and the second drive control signal PWMB to the full bridge circuits 103 and 104 through the gate drivers 21 and 22, to control the current flowing through the first winding 105 and the second winding 106 to be close to the current setting values. In addition, when a rising edge of a zero-current step signal ZCS of the step signal STEP comes, the stepper motor 100A steps into a zero-current step interval in which the current drops to zero, and the two full bridge circuits 103 and 104 control a specific low side switch to be kept in conduction state. The specific low side switch is coupled to a first terminal of a winding in which the current drop to zero in a first time interval of the zero-current step interval. During the zero-current step interval, in a second time interval after the first time interval, a voltage at a second terminal of the winding in which the current drops to zero is sampled, to provide the back electromotive force.

The interface circuit 27 is configured to perform data communication with the master controller 101, and can receive setting data, such as a step mode data, a current configuration table, etc., from the master controller 101. The interface circuit 27 may comprise I2C interface, SPI interface, etc. In one embodiment, SPI communication is used between the logic control circuit 20 of the two-phase bipolar stepper motor 100A and the master controller 101. The logic functions of SPI communication comprise serial clock input (SCLK), serial data input (SDATI), serial data output (SDATO), and a chip select input (nSCS). In one embodiment, the driver circuit 102 further comprises registers for storing the setting data received by the interface circuit 27.

In one embodiment of the present invention, the driver circuit 102 detects the voltage at the second terminal of the winding in real time without using an external sensor or encoder feedback, to provide the back electromotive force, and thus determines whether the stepper motor 100A is stalled. Specifically, the driver circuit 102 determines the zero-crossing direction of the current flowing through the winding in which the current drops to zero in the first time interval. During the zero-current step interval, the driver circuit 102 responds to the zero-crossing direction of the current and controls a specific low side switch be kept in the conduction state in the second time interval following the current zero-crossing. The specific low side switch is coupled to a first terminal of the winding in which the current drops to zero in the first time interval. A voltage at the second terminal of the winding in which the current drops to zero in the first time interval is sampled, to provide the back electromotive force induced by the winding in which the current drops to zero in the first time interval.

Since the embodiment of the present invention only needs to detect the voltage at the second terminal of the winding, this avoids the delay problem inherent in detecting two terminal voltages. Therefore, the requirement for the length of the sampling window becomes lower, and this invention can be used for situations where the zero-current step interval is relatively small, such as micro-stepping mode of the stepper motor 100A.

In one embodiment, when the master controller 101 detects that the motor 100A is stalled by receiving the back electromotive force information provided through the interface circuit 27, the master controller 101 immediately disable the motor through the enable pin ENBL, to stop and protect the stepper motor 100A.

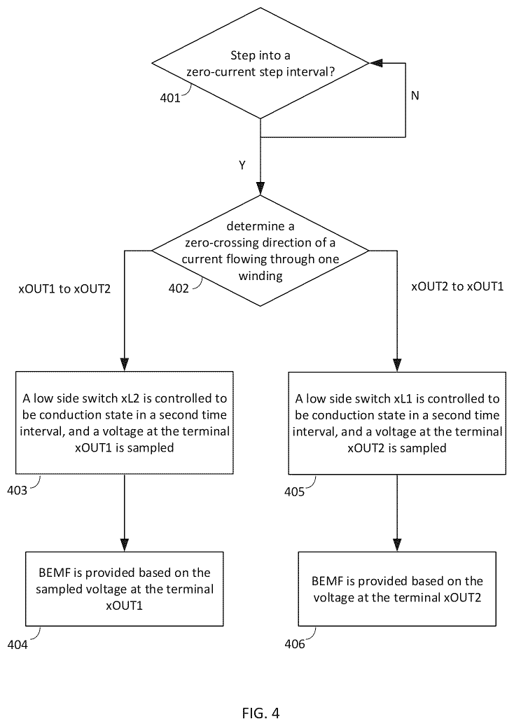

FIG. 4 shows a flow diagram of a method for detecting a back electromotive force in a stepper motor in accordance with an embodiment of the present invention. The stepper motor has a first and second full-bridge circuits, a first and second windings and a rotor, wherein in response to the step signal, the first and second full-bridge circuits respectively drive the first and second windings to move a rotor in a step rotation. The method includes steps 401 to 406.

At step 401, whether the stepper motor steps into a zero-current step interval is decided. Since the sampling point of the back electromotive force needs to ensure that the current flowing through the winding actually reaches zero, the zero-current step interval is configured to have a first time interval and a second time interval. In the first time interval, the current flowing through the winding drops to zero.

At step 402, a zero-crossing direction of the current flowing through one winding in which the current drops to zero in the first time interval is determined. If the zero-crossing direction of the current is from the terminal xOUT1 to the terminal xOUT2 (where the “x” refers to A or B, e.g., from the terminal AOUT1 to the terminal AOUT2, or from BOUT1 to BOUT2), then go step 403. If the zero-crossing direction of the current is from the terminal xOUT2 to the terminal xOUT1, then go step 5.

At step 403, the low side switch xL2 coupled to the terminal xOUT2 is controlled to keep in the conduction state in the second time interval. And the voltage at the terminal xOUT1 is sampled and detected.

At step 404, a back electromotive force induced by the winding in which the current drops to zero in the first time interval is provided based on the sampled voltage at the terminal xOUT1. In a further embodiment, the detection of the back electromotive force ends when the zero-current step interval ends. In another embodiment, the low side switch xL2 is turned off no later than the end of the zero-current step interval.

At step 405, the low-side switch xL1 coupled to the terminal xOUT1 is controlled to keep in the conduction state in the second time interval. And the voltage at the terminal xOUT2 is sampled and detected.

At step 406, the back electromotive force induced by the winding in which the current drops to zero in the first time interval, is provided based on the sampled voltage at the terminal xOUT2. In one embodiment, after the step 406, the low side switch XI1 is turned off no later than the end of the zero-current step interval.

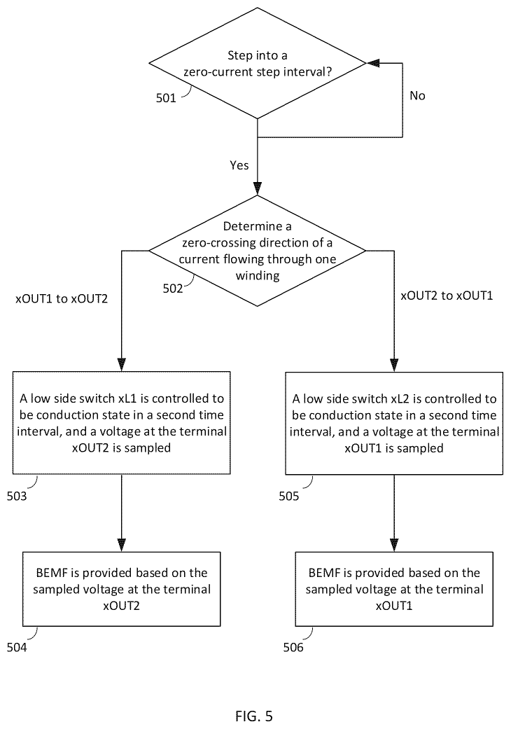

In practical applications, the status of the stepper motor is relatively complex. When the rotation speed is slow, the speed of the rotor is not constant, sometimes fast and sometimes slow, and the rotor may even oscillate back and forth several times when moving the rotor to the next step rotation. Under different load conditions, the sampled voltage may be negative, which makes it difficult to detect the back electromotive force. In order to ensure that the detected back electromotive force is always positive under different load conditions, the back electromotive force detection process can use the embodiments shown in FIG. 4 or FIG. 5.

FIG. 5 shows a flow diagram of a method for detecting a back electromotive force in a stepper motor in accordance with another embodiment of the present invention. The stepper motor has a first and second full-bridge circuits, a first and second windings and a rotor. In response to a step signal, the first and second full-bridge circuits respectively drive the first and second windings to move the rotor in a step rotation. The method comprises steps 501 to 506.

At step 501, whether the stepper motor steps into a zero-current step interval is decided. Each zero-current step interval is configured to have a sequential first time interval and a second time interval. During the first time interval, a current flowing through one winding drops to zero.

At step 502, a zero-crossing direction of the current flowing through the winding in which the current drops to zero in the first time interval is determined. If the zero-crossing direction of the current is from the terminal xOUT1 to the terminal xOUT2, go step 503. If the zero-crossing direction of the current is from the terminal xOUT2 to xOUT1, go step 505. Where the “x” refers to A or B.

At step 503, the low side switch xL1 coupled to the terminal xOUT1 is controlled to keep in the conduction state in the second time interval. And the voltage at the terminal xOUT2 is detected and sampled.

At step 504, a back electromotive force induced by the winding in which the current drops to zero in the first time interval is provided based on the sampled voltage at the terminal xOUT2.

At step 505, the low side switch xL2 coupled to the terminal xOUT2 is controlled to keep in the conduction state in the second time interval, and the voltage at the terminal xOUT1 is detected and sampled.

At step 506, a back electromotive force induced by the winding in which the current drops to zero in the first time interval is provided based on the sampled voltage at the terminal xOUT1.

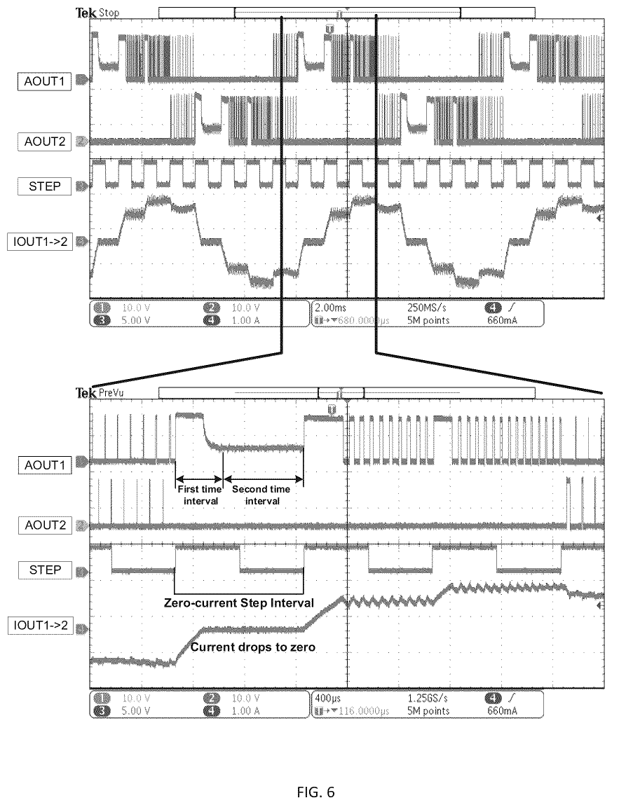

FIG. 6 shows working waveforms of a back electromotive force detection in a stepper motor in accordance with another embodiment of the present invention. As shown in FIG. 6, the back electromotive force is detected and provided in the zero-current step interval, and all work modes except full-step mode can be detected.

As shown in FIG. 6, the current IOUT1->2 refers to the current flows from AOUT1 to AOUT2. The current IOUT1->2 flowing through the first winding 105 drops to zero. In the labelled zero-current step interval, a voltage sampling point needs to be set in the second time interval flowing the first time interval in which the current drops to zero. The zero-crossing direction of the current is from negative to zero, or from AOUT1 to AOUT2, the voltage at the terminal AOUT2 is lower than the voltage at the terminal AOUT1. In response to the zero-crossing direction of the current shown in FIG. 6, in the second time interval, the lower side switch AL2 is selected and controlled to keep in the conduction state, and the voltage at the terminal AOUT1 is sampled and detected to provide the back electromotive force.

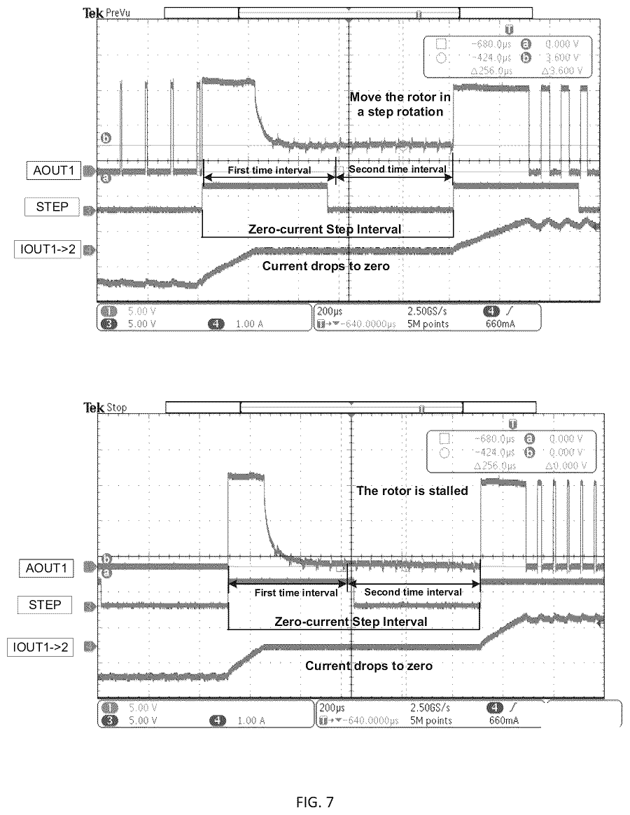

FIG. 7 shows working waveforms of a stepper motor when stall occurs or no stall in accordance with an embodiment of the present invention. As shown in FIG. 7, the back electromotive force can be used to detect whether a stall occurs.

The two waveforms are compared in FIG. 7. An upper waveform is the back electromotive force waveform when the stepper motor moves the rotor in the step rotation. A lower waveform is the back electromotive force waveform when the stepper motor is stalled. Since the back electromotive force is generated when the motor rotates, according to the embodiment of the present invention, in the second time interval of the zero-current step interval labelled in FIG. 7, after the current flowing through the first winding 105 drops to zero, the voltage at the terminal AOUT1 is not zero when there is no stall. In contrast, if the stall occurs, as shown in the lower waveform, in the second time interval of the zero-current step interval labelled in FIG. 7, the voltage at the terminal AOUT1 is close to zero. Embodiments of the present invention use the back electromotive force to detect whether the stepper motor is stalled.

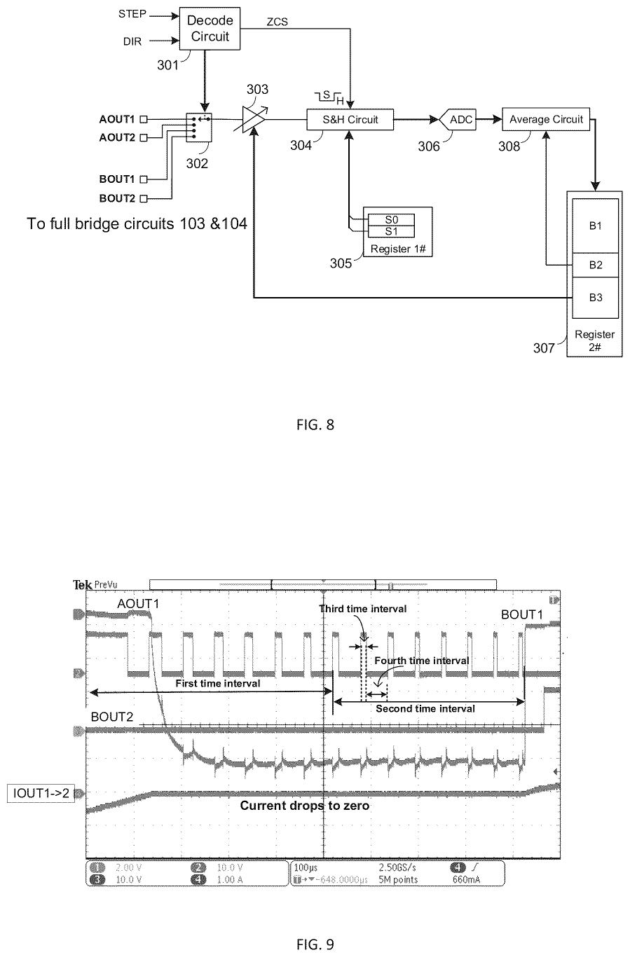

FIG. 8 shows a circuit diagram of a back electromotive force detection circuit in accordance with an embodiment of the present invention. As shown in FIG. 8, the back electromotive force detection circuit of the driver circuit 102 comprises a decode circuit 301, a channel selection circuit 302, an operational amplifier 303, a sample-and-hold circuit 304, an analog-to-digital converter (ADC) 306 and an average circuit 308.

In the embodiment shown in FIG. 8, the decode circuit 301 provides a channel selection signal and a zero-current step signal ZCS after decoding, based on the step signal STEP, the direction signal DIR and current configuration table, step drive mode data and other information, to determine a sampling channel. The channel selection circuit 302 selects one of the four output terminals to be coupled to an input terminal of the operational amplifier 303 based on the channel selection signal provided by the decode circuit 301.

Since a value of the back electromotive force is related to the motor design parameters, an adjustable gain operational amplifier 303 is used to convert the value of the back electromotive force to a suitable voltage range. In one embodiment, the voltage range is 0-5V.

The sample-and-hold circuit 304 receives the zero-current step signal ZCS provided by the decode circuit 301 and is configured to sample and hold the back electromotive force provided by the operational amplifier 303 through sampling and conversion. The sampling point of the sample-and-hold circuit 304 is adjusted to be after the first time interval and before the end of the zero-current step interval. In the embodiment of the present invention, when a rising edge of the zero-current step signal ZCS comes, the motor enters the zero-current step interval. When the next rising edge of the step signal STEP comes, the zero-current step interval ends. The sample-and-hold circuit 304 samples and holds the output of the operational amplifier 303 in the second time interval of the zero-current step interval, and outputs an analog value of the back electromotive force. The sample-and-hold circuit 304 sends the analog value of the back electromotive force to the analog-to-digital converter 306. Once the back electromotive force value is converted into a digital value by the analog-to-digital converter 306, the driver circuit 102 can determine whether the stepper motor is stalled through the logic control circuit 20.

The above process requires many parameters to be adjusted to ensure detection accuracy. For example, the first time interval can be adjusted to be wider or shorter. The key is the current drops to zero in the first time interval. In one embodiment, the driver circuit 102 further includes a register 305, which is used to set a length of the first time interval. In one embodiment, the first time interval is optionally set to ¼, ½ or ¾ of the length of the zero-current step interval. This is because, ideally, when the rising edge of the zero-current step interval comes, the winding current just crosses zero. However, in practical applications, a first time interval needs to be set to ensure detection accuracy.

In one embodiment, the analog-to-digital converter 306 stores a real-time sample value provided by the sample-and-hold circuit 306 to a register 307. In another embodiment, the back electromotive force detection circuit can provide an average value from several consecutive sampling. The greater the number of average values, the more accurate the result obtained. However, averaging will cause the acquisition of the back electromotive force to be slower, so the accuracy benefit brought by the number of averages must be weighed against the response speed under specific application requirements. In one embodiment, the register 307 has three subunits B1^{˜}B3. The subunit B1 is used to adjust the gain or attenuation of the operational amplifier 303. The subunit B2 is used to select whether to enable or adjust the average circuit 308 to determine whether the back electromotive force stored in the register 307 is a real-time value or an average of multiple sampled values. The subunit B3 is used to store the detection results of the back electromotive force. In a further embodiment, the master controller 101 can directly read the detection result of the back electromotive force through the interface circuit 27.

In the embodiment of the invention, the stepper motor has two windings 105 and 106. When detecting the back electromotive force in a winding in which the current drops to zero, it is sometimes affected by switching noise from the other winding in which the current is not zero. A method is proposed to overcome this shortcoming. That is, when the current in one winding drops to zero, it will wait for the two low side switches coupled to the other winding in which the current is not zero, to conduct, and then sample the back electromotive force from the winding in which the current drops to zero. In this way, switching noise due to coupling between two windings can be virtually eliminated to obtain accurate back electromotive force detection.

FIG. 9 shows working waveforms of a back electromotive force detection in a stepper motor in accordance with yet another embodiment of the present invention. As shown in FIG. 9, the stepper motor steps to the zero-current step interval, and the current flowing through the first winding 105 drops to zero in the first time interval.

In the second time interval, in response to the zero-crossing direction of the current flowing through the first winding 105, the low side switch AL2 at the terminal AOUT2 is controlled to be kept in conductive state. The second time interval is configured to have a sequential third time interval and a fourth time interval. In the third time interval, the low side switch BL2 of the full bridge circuit 104 that drives the second winding 106 in which the current is not zero, remains on, the low side switch BL1 remains off, and the high side switch BH1 remains on. In the fourth time interval, both low side switches BL1 and BL2 of the full-bridge circuit 104 driving the second winding 106 are turned on. In the fourth time interval, the voltage at the terminal AOUT1 of the first winding 105 is sampled to provide the back electromotive force induced by the first winding 105, to avoid the interference of switching noise from the winding 106 in which the current is not zero.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated, and they obviously will be resorted to by those skilled in the art without departing from the spirit and the scope of the invention as hereinafter defined by the appended claims as only a preferred embodiment(s) thereof has been disclosed.

What is claimed is:

1. A method of detecting a back electromotive force in a stepper motor having two full bridge circuits and two windings respectively driven by the two full bridge circuits, the method comprising:
stepping the stepper motor into a zero-current step interval having a sequential first time interval and a second time interval;
determining a zero-crossing direction of a current flowing through a first winding in which the current drops to zero in the first time interval;
in the second time interval, controlling a specific low side switch to keep in a conduction state in response to the zero-crossing direction of the current, wherein the specific low side switch is coupled to a first terminal of the first winding;
sampling a voltage at a second terminal of the first winding; and
providing the back electromotive force induced by the first winding based on the sampled voltage.

2. The method of claim 1, wherein the second time interval is configured to have a sequential third time interval and a fourth time interval, wherein:
in the third time interval, both of two low side switches of a second full bridge circuit are not conducting, wherein the second full bridge circuit is configured to drive a second winding in which the current is not zero.

3. The method of claim 2, wherein in the fourth time interval, both of the two low side switches of the second full bridge circuit are conducting.

4. The method of claim 2, wherein:
in the fourth time interval, sampling the voltage at the second terminal of the first winding.

5. The method of claim 1, further comprising:
ending the conduction state of the specific low side switch no later than the end of the zero-current step interval.

6. The method of claim 1, wherein the stepper motor works in a bipolar mode.

7. The method of claim 1, wherein providing the back electromotive force comprising:
sampling multiple voltages at the second terminal of the first winding; and
storing an average of the multiple sampled voltages to a register.

8. A stepper motor, comprising:
two windings;
a rotor;
a driver circuit having two full bridge circuits configured to respectively drive the two windings, the driver circuit is configured to determine a zero-crossing direction of a current flowing through a first winding in a zero-current step interval, wherein the zero-current step interval has a sequential first time interval in which the current flowing through the first winding drops to zero and a second time interval; and wherein
in the second time interval, in response to the zero-crossing direction, the driver circuit is configured to control a specific low side switch coupled to a first terminal of the first winding to keep in a conduction state and to provide a back electromotive force induced by the first winding by sampling a voltage at a second terminal of the first winding.

9. The stepper motor of claim 8, wherein the second time interval is configured to have a sequential third time interval and a fourth time interval, wherein:
in the third time interval, both of two low side switches of a second full bridge circuit are not conducting, wherein the second full bridge circuit is configured to drive the second winding in which a current is not zero.

10. The stepper motor of claim 9, wherein in the fourth time interval, both of the two low side switches of the second full bridge circuit are conducting.

11. The stepper motor of claim 9, wherein the voltage at the second terminal of the first winding is sampled in the fourth time interval to provide the back electromotive force.

12. The stepper motor of claim 8, wherein the specific low side switch is turned off no later than the end of the zero-current step interval.

13. The stepper motor of claim 8, wherein the stepper motor is configured to work in a bipolar mode.

14. The stepper motor of claim 8, wherein:
the driver circuit is configured to sample multiple voltages at the second terminal of the first winding and to store an average of the multiple sampled voltages to a register.

15. A driver circuit for a stepper motor, comprising:
an input terminal connected to receive a step signal;
a direction terminal connected to receive a direction signal;
a first pair of output terminals configured to be respectively coupled to a first terminal and a second terminal of a first winding;
a second pair of output terminals configured to be respectively coupled to a first terminal and a second terminal of a second winding;
two full bridge circuits configured to respectively drive the first winding and the second winding; and wherein
the driver circuit is configured to determine a zero-crossing direction of a current flowing through the first winding in which the current drops to zero in a zero-current step interval; and wherein
during the zero-current step interval, in a time interval following the zero-crossing of the current, in response to the zero-crossing direction, the driver circuit is configured to control a specific low side switch coupled to the first terminal of the first winding to keep in a conduction state and to provide a back electromotive force by sampling a voltage at the second terminal of the first winding.

16. The driver circuit of claim 15, wherein the time interval is configured to have a sequential third time interval and a fourth time interval, wherein:
in the third time interval, both of two low side switches of the second full bridge circuit are not conducting, the second full bridge circuit is configured to drive the second winding in which a current is not zero; and
in the fourth time interval, both of the two low side switches of the second full bridge circuit are conducting.

17. The driver circuit of claim 16, wherein the voltage at the second terminal of the first winding is sampled in the fourth time interval to provide the back electromotive force.

18. The driver circuit of claim 15, wherein the specific low side switch is turned off no later than the end of the zero-current step interval.

19. The driver circuit of claim 15, further comprising:
an interface circuit coupled to a mater controller for data communication.

20. The driver circuit of claim 15, wherein the driver circuit is configured to sample multiple voltages at the second terminal of the first winding and to store an average of the multiple sampled voltages to a register.
